(19) United States
(12) Patent Application Publication
(10) Pub. No.: US 2017/0374071 A1
(43) Pub. Date: Dec. 28, 2017

(54) SYSTEMS AND METHODS FOR CONTROLLING ACCESS TO WIRELESS SERVICES

(71) Applicant: BANDWIDTHX INC., Carlsbad, CA (US)

(72) Inventors: Pertti Juhani VISURI, Carlsbad, CA (US); Randy SALO, Carlsbad, CA (US); Christian VAN HAMERSVELD, Carlsbad, CA (US)

(21) Appl. No.: 15/540,822

(22) PCT Filed: Dec. 30, 2015
(86) PCT No.: PCT/US2015/068182

§ 371 Date: Jun. 29, 2017

Related U.S. Application Data
(60) Provisional application No. 62/098,830, filed on Dec. 31, 2014.

(51) Int. Cl. H04L 29/06; H04W 12/06; H04W 12/08; H04W 88/12

(52) U.S. Cl. CPC H04L 63/0892; H04W 12/08; H04L 63/101; H04W 12/06; H04W 88/12

(57) ABSTRACT

This disclosure provides a system and method for wireless communication. The system can include a plurality of access points for providing a service. The system can also have a wireless device that can associate and communicate with one or more authorized access points identified by an access controller. The access controller can provide the wireless device with a configuration profile identifying the one or more authorized access points within the plurality of access points. The wireless device can use login credentials to use the service and include additional information associated with the authorized access point in the login credentials when initiating the connection. The access controller can also receive the login credentials and additional information used by the wireless device to initiate the connection with the authorized access point. The access controller can also determine whether the connection is desirable and authorize the connection.

### BACKGROUND

### Technological Field

This disclosure relates to wireless service to mobile electronic devices. More specifically, this disclosure relates to enabling commerce between mobile wireless device users and wireless or radio communication systems via a central access controller.

### Related Art

Wireless communication networks are widely deployed to provide various communication services such as voice, video, packet data, messaging, broadcast, and the like. These wireless networks may be multiple-access networks capable of supporting multiple users by sharing the available network resources. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). Examples of multiple-access network formats include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

### SUMMARY

In general, this disclosure describes systems and methods related to enabling mobile wireless device users to utilize wireless access points. The systems, methods and devices of this disclosure each have several innovative aspects, no single one of which is solely responsible for the desirable attributes disclosed herein.

One aspect of the disclosure provides a method for operating an access controller for wireless communication. The method can include transmitting, at the access controller, a configuration profile to a wireless device, the configuration profile identifying one or more authorized access points. The method can also include receiving, from an authentication server, login credentials used by the wireless device to initiate a connection with an access point of the one or more authorized access points. The login credentials can include additional information added by the wireless device at the time the wireless device initiates the connection with the access point. The method can also include determining, at the access controller, based on information associated with the access point and the additional information, that the connection is desirable. The method can also include allowing, by the access controller, the connection between the wireless device and the access point.

Another aspect of the disclosure provides an access controller for wireless communication. The access controller can have at least one memory configured to store one or more configuration profiles. Each configuration profile of the one or more configuration profiles can identify one or more authorized access points. The access controller can also have one or more processors operably coupled to the at least one memory. The one or more processors can communicate a configuration profile of the one or more configuration profiles to a wireless device. The one or more processors can also receive, from an authentication server, login credentials used by a wireless device to establish a connection with an access point of the one or more authorized access points in the configuration profile. The login credentials can include additional information added by the wireless device when the wireless device initiates the connection with the access point. The one or more processors can also determine that the connection is desirable based on information associated with the access point and the additional information. The one or more processors can also allow the connection between the wireless device and the access point.

Another aspect of the disclosure provides an apparatus an apparatus for wireless communication. The apparatus can have means for transmitting a configuration profile to a wireless device, the configuration profile identifying one or more authorized access points. The apparatus can also have means for receiving login credentials used by the wireless device to initiate a connection with an access point of the one or more authorized access points in the configuration profile. The login credentials including additional information added by the wireless device. The apparatus can also have means for determining based on information associated with the access point and the additional information, that the connection is desirable. The apparatus can also have means for allowing the connection between the wireless device and the access point.

Another aspect of the disclosure provides a system for wireless communication. The system can have a plurality of access points configured to provide a service. The system can also have a wireless device can initiate a connection with an authorized access point of one or more authorized access points of the plurality of access points using login credentials to use the service. The wireless device can also append, to the login credentials, additional information associated with the authorized access point when initiating the connection. The system can also have an access controller. The access controller can provide the wireless device with a configuration profile identifying the one or more authorized access points. The access controller can also receive from an authentication server. The login credentials used by the wireless device to initiate the connection with the authorized access point. The access controller can also determine, based on information associated with the access point and the additional information, that the connection is desirable. The access controller can also allow the connection between the wireless device and the authorized access point

Other features and advantages of the present disclosure should be apparent from the following description which illustrates, by way of example, aspects of the disclosure.

### BRIEF DESCRIPTION OF THE FIGURES

The details of embodiments of the present disclosure, both as to their structure and operation, may be gleaned in part by study of the accompanying drawings, in which like reference numerals refer to like parts, and in which:

FIG. 1 is a functional block diagram of an embodiment of a wireless communication system;

FIG. 2 is a functional block diagram of another embodiment of the wireless communication system of FIG. 1;

FIG. 3 is a flowchart of a method for selecting wireless services in the system of FIG. 2; and

FIG. 4 is a flowchart of another method selecting wireless services in the system of FIG. 2; and

FIG. 5 is a functional block diagram of a wireless device.

### DETAILED DESCRIPTION

The detailed description set forth below, in connection with the accompanying drawings, is intended as a description of various embodiments and is not intended to represent the only embodiments in which the disclosure may be practiced. The detailed description includes specific details for the purpose of providing a thorough understanding of the embodiments. In some instances, well-known structures and components are shown in simplified form for brevity of description.

IEEE 801.XX Wi-Fi systems, capacity, and connections to the Internet can provide a significant portion of wireless connectivity for mobile devices that might otherwise rely on cellular (e.g., CDMA, LTE, LTE-A, GSM, GPRS, etc.) connections provided by various mobile network operators. This wireless network resource can be extended outside the device owner's home and work environment by automating connections to third party Wi-Fi networks. The third party networks provide an opportunity for mobile network operators to purchase Wi-Fi access when and where needed based on policies, prices, and access conditions defined by the sellers and users. The policies, prices, and access conditions are described in U.S. patent application Ser. No. 13/684,048 and U.S. patent application Ser. No. 14/225,310, which are incorporated by reference herein in their entirety.

The solutions described in these applications can use network selection mechanisms that involve determining which access network to use based on various conditions. The selection mechanism can operate within the mobile device for this determination and routing the data traffic. Implementing the conditional network connection decision making in the mobile device may not always be practical due to the requirement for user interface and latency, for example. However conditional access to Wi-Fi networks and network resource marketplaces may provide certain efficiencies without the need for implementing the decision and connection selection in the mobile device.

The systems and methods described herein can enable wireless mobile devices (devices) and access points (AP) to conduct (micro)-commerce for bandwidth or data connectivity. Embodiments of the disclosure provide an exchange that can be governed by certain agreements between wireless (or wired) service providers and individual mobile device users as well as with a number of individuals or companies that operate or control the wireless access points, such as for example, a Wi-Fi AP or a cellular tower.

The system as described herein can provide centralized access control for use with one or more devices and one or more wireless services. Based on the availability and desirability of a certain wireless service, a centralized access controller can authorize a device to connect with an available or desired service. This can allow the access controller to make a commercial judgement as to whether to allow a given connect between the device and the AP during authentication with the wireless service.

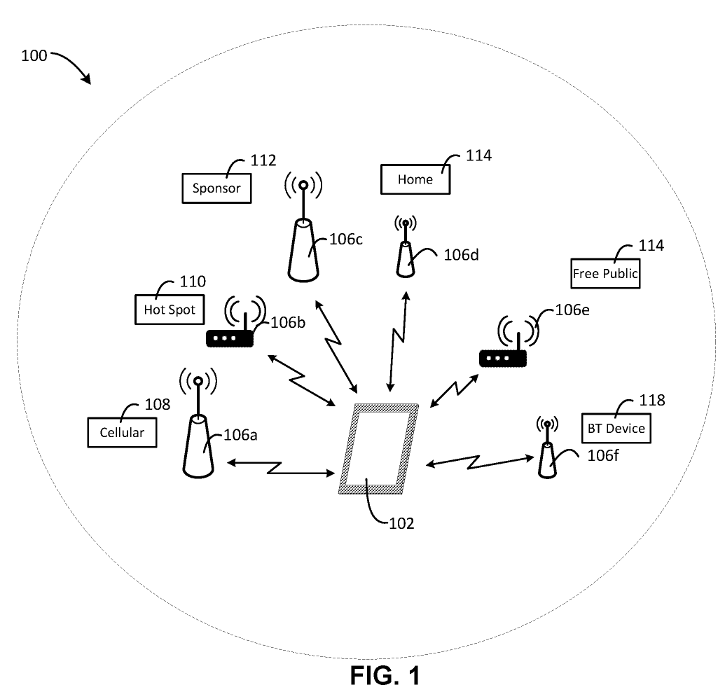

FIG. 1 is a functional block diagram of an embodiment of a wireless communication system. A wireless communications (system) 100 can have a mobile device 102. The mobile device (device) 102 can be a mobile electronic terminal, capable of wireless communications via one or more wireless services to, for example, one or more other devices 102. The device 102 can also be referred to herein as a user equipment (UE), a mobile station (MS), or mobile terminal (MT). The device 102 can be a cellular phone, tablet, or other mobile electronic communication system capable of communications over one of several communication standards, such as 2G (e.g., Global System for Mobile Communications (GSM), General packet radio service (GPRS), Enhanced Data rates for GSM Evolution (EDGE), iDEN, Time division multiple access (TDMA), Code division multiple access (CDMA)), 3G (e.g., CDMA2000, 1X-EVDO, P25-LMR, wideband CDMA (WCDMA), Universal Mobile Telecommunications System (UMTS), HSPA), 4G (e.g., Long Term Evolution (LTE), Worldwide Interoperability for Microwave Access (WiMAX)), Voice Over IP (VoIP), Internet Protocol (IP) Multimedia Subsystem (IMS), IP television (IPTV), Wireless Local Area Networking (WLAN), Wi-Fi (e.g., one or more of the family of IEEE 802.11 standards), Bluetooth, and other radio-based wireless protocols, to communicate with another mobile device 102 or a remote device such as for example, a Bluetooth keyboard, headset, or other accessory. In some examples, the device 102 can communicate via one or more communication services facilitated by a cellular tower or base station of a cellular network. The cellular standards can be one or more of 2G, 3G, 4G, Long Term Evolution (LTE), LTE-Advanced, GSM, GPRS, CDMA, or another wireless standard known in the art. However, it should be understood that the same mechanisms and principles can be used to implement the system 100 and connection selection functions for any other radio system (e.g., Bluetooth and Wi-Fi) as well. For convenience, LTE and Wi-Fi may be referred to herein as exemplary standards for use with the system 100.

The device 102 can participate in communication via one or more different communication systems over multiple communication standards simultaneously. For example, the device 102 can have an LTE connection with a cellular provider 108 for a telephone conversation, a Bluetooth connection to a wireless headset, such as a Bluetooth (BT) enabled device 118, while also receiving email via an IEEE 802.11 standard connection with a local Wi-Fi hotspot 110.

The wireless services can be provided via one or more access points (AP) 106. The access points 106 are depicted as APs 106a-106f, but may collectively be referred to herein as APs 106. The APs 106 may also be referred to herein individually as the AP 106. The APs 106 can be implemented to provide a variety of wireless services. For example, the cellular provider 108 can have an AP 106a to provide cellular (e.g., LTE) service. An AP 106b can be used as a stationary or mobile Wi-Fi hot spot 110. An AP 106c can be operated by sponsor 112, such as a small-scale network operated by a vendor. An AP 106d can be a pico cell or a home network 114. An AP 106e can be implemented to provide free public Wi-Fi 116 connections, at for example, an airport. An AP 106f can also be implemented as a Bluetooth (BT) device 118, such as a speaker or wireless headset.

Any of the connections to the APs 106 may be available free of charge (as the name may imply) or the connections may require login credentials, a subscription, or a per unit (e.g., time, data, data rate, distance) charge. In still other embodiments, the sponsored connection 108 can provide sponsored content, for example, targeted advertisements or subsidized wireless services for use in a specific location. For example, these services can be provided to the device 102 while in a particular store or establishment. The selection of which services are required by the device 102 may be a result of several factors described below.

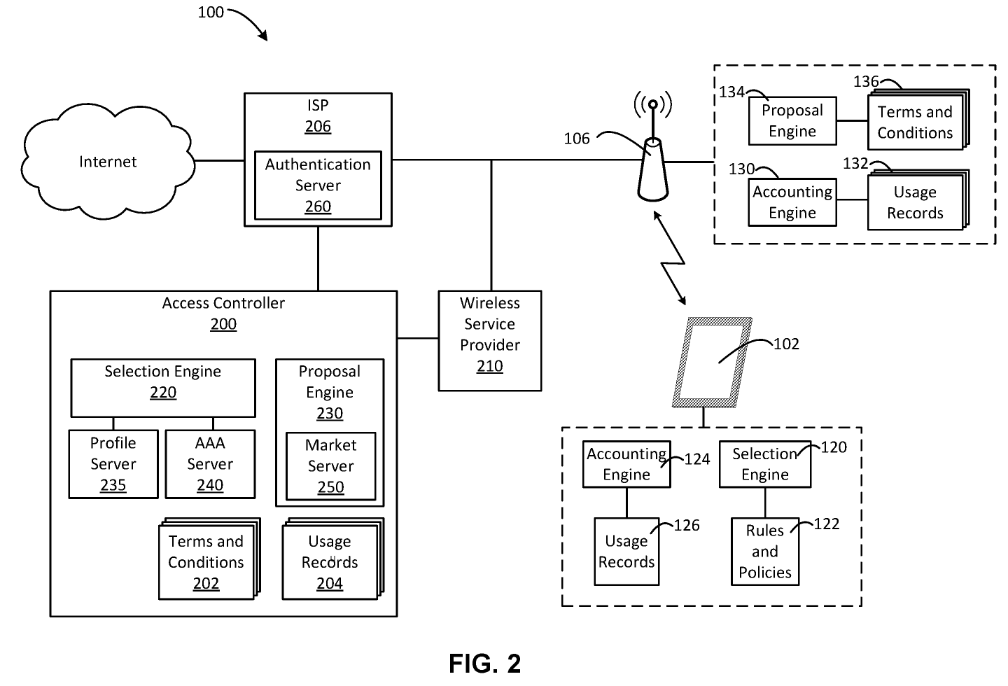

FIG. 2 is a functional block diagram of another embodiment of the system of FIG. 1. The system 100 can have the device 102, the one or more APs 106 and an access controller 200. In some embodiments, the system 100 can act as a marketplace or commercial ecosystem for the control, distribution of, and payment for services and connectivity from an Internet Service Provider (ISP) 202 via the APs 106. In some embodiments, the services are wireless services provided by one or more service providers 210 to the device 102. The service providers 210 can each operate or control the APs 106 as described above in connection with FIG. 1. In some embodiments, the access controller 200 is at the core of the system 100. The access controller 200 can distribute, authorize, and/or authenticate the connections made by the device 102, as described below. In some embodiments, the access controller 200 can select and authorize one or more connections between the device 102 and the service providers 210. Such an embodiment can include the Bandwidth X Marketplace, “BX Market.” The BX Market can enable an exchange of authorized or subscribed services for payment. In some embodiments, the access controller 200 can make commercial judgments as to authorized connections (e.g., the between the device 102 and the APs 106) during an authentication process.

As used herein, the commercial exchange of services for payment in the system 100 may be referred to as “micro-commerce.” The access controller 200 can manage all the information to enable the micro-commerce between operators (e.g., the service providers 210), the AP's 106, the ISP 206, and the device or devices 102. The system 100 can then manage the billing and payments between all parties. In one embodiment, the BX Market can be implemented as one or more modules on a server.

The system 100 can have the device 102 and the one or more of the APs 106. The device 102 can be in wireless communications with the one or more APs 106, for example the cellular provider 108 via the AP 106a and the hot spot 110 via the AP 106b. The APs 106 can further be in communication with an access controller 200. Such communications can be executed wirelessly or via a wireline connection.

The device 102 can have a selection engine 120. The selection engine 120 can be implemented as one or more processors configured or operable to manage the connectivity with the one or more other devices 102 and one or more APs 106, for example. The selection engine 120 can select one or more available wireless connections based on offered services and needs of the device 102. The selection engine 120 can make decisions based on rules and policies stored in a rules and policies database (RPdb) 122. The RPdb 122 can be a memory unit or series of memory units within the device 102 configured to store the rules and policies. The rules and policies can be preferences set and controlled by the end user of the device or a wireless operator. The RPdb 122 can also have a set of default settings provisioned as defaults settings on the device 102.

### Selection Engine

The selection engine 120 can use the rules and policies to control which of the available wired or wireless connections to the device 102 are selected at any given time. The selection engine 120 can establish a wireless connection for each application within the device 102 that needs a data connection.

The level of sophistication in the selection process may vary between implementations. In some embodiments, several factors, or routing criteria, are included in the decision-making at the selection engine 120. These factors or a subset of these factors can be collected for each available wireless connection (e.g., the APs 106). For example, a factor may be a per-unit (e.g., time/data) commercial cost of the wireless connection to a sponsored link (e.g., the AP 106b) that advertises or offers particular services. Certain terms and conditions 136 of using each connection can also be present. The terms and conditions 136 can dictate, for example, pricing and how the connection with each AP 106 is used and administered. The terms and conditions 136 are described in more detail below.

In some embodiments, the routing criteria can include signal strength, or a received signal strength indication (RSSI), quality of service (QoS), signal-to-noise ratio (SNR) or other relevant signal-specific parameters available from one or more of the APs 106.

In some embodiments, factors can include a level of security available for using the available connections to one or more of the APs 106.

In some embodiments, factors can include a throughput capacity of the connection, a reliability (packet loss) of the connection, and latency and jitter of the connection to the AP 106.

In some embodiments, factors can include a bandwidth need, requirement, or request from the device 102. This can also include any other need for specific connection characteristics, or for example, needs relating to a particular application running on the device 102.

In some embodiments, factors can include a specific universal resource locator (URL), web site, or specific service to which the application (on the device 102) is requesting to access.

In some embodiments, factors can include information regarding special promotions or sponsorship for available connections. This can relate to the sponsored AP 106c, for example.

In some embodiments, factors can include an acceptability of delay in transmitting data. Such a delay or latency can include the time elapsed from when the original request by an application was made for the data transmission. This can be specified for example, by the application provider or the end user (of the device 102). The factors and settings can also be application-specific. For example, a used may specify an acceptable to delay for uploading photographs to a given website. The device 102, and more particularly, the selection engine 120, may await another connection with better characteristics before selecting a connection with, for example, a non-zero price tag. The selection engine can also have different acceptable delays for using different cost levels or other specified characteristics of connections.

In some embodiments, other factors can include an estimated drain on battery power of using the connection. If the features of a particular AP 106 are known to have power intensive requirements, that may factor into a decision made by the selection engine 120.

In some embodiments, factors can include speed, reliability, or other physical characteristics of a connection that the device 102 is currently using or has used in the past.

In some embodiments, factors can include a geographic location of the device 102 in relation to the AP 106. This can also include information about the movement of the device 102 gleaned from onboard motion sensors, accelerometers, or from GPS tracking data.

The rules and policies can also include other variables not listed above. It should therefore be appreciated that the foregoing is not an exhaustive list of the factors the selection engine 120 can use to select an AP 106. Additional or special instructions from the network operators may further comprise factors considered for rules and policies.

For example, some connection alternatives may be free of charge or have lower cost but may require acceptance of certain commercial messages and advertising. Other choices may only provide access to certain web sites or limited services. For example, service providers or vendors may sponsor connectivity that allows the end user to visit their website and make purchases. Other APs 106 may offer lower cost or free connectivity but require the right to collect location-based information of the user or may require responses to surveys.

The selection engine 120 can use a combination of information to implement the rules and policies from the RPdb 122 for selecting one or more wireless connections for use by the device 102. In an embodiment, the selection engine 120 in the device 102 maintains a memory of available connections provided by the APs 106, or other available wireless communications. In some embodiments, certain other connections such as the wireless or cellular provider 108, a hot spot 110, sponsored content from a particular vendor or sponsor 112, a home Wi-Fi system 114, or free public Wi-Fi 116 can be available for connection. In certain embodiments, the foregoing connections are grouped in FIG. 2 as the wireless service providers 210. The selection engine 120 can maintain a memory of each available wireless connection.

The selection engine 120 can select which among various data connections is preferred for use by the device 102. In an embodiment the selection engine 120 can accomplish this on a real time, moment-to-moment basis, based on the rules and policies, terms and conditions 136 of use for the service, and other current information. The current information can include those routing criteria, factors, and characteristics regarding each available connection listed above.

In some embodiments, some or all of the functions of the selection engine 120 at the device 102 can be implemented at the access controller 200 as described below.

### Accounting Engine

The device can also have an accounting engine 124. The accounting engine 124 can be one or more processors at the device that can account for, or keep track of services used or consumed by the device 102. The accounting engine 124 can be coupled to one or more memories to which the accounting engine 124 can store usage records 126. The usage records 126 can store statistics and records of what services are used and how much data or bandwidth is consumed by the device 102. The device 102 can reference the usage records 126 when required in order to report usage to a provider of wireless services or when payment for wireless services is due. In some embodiments the accounting engine 124 can reference the usage records 126 and report the usage of various wireless services to the access controller 200.

The accounting engine 124 can collect and provide the data for the use of bandwidth and services within the system 100. The accounting engine 124 keeps track of the capacity utilized by the device 102 through each enabled connection with the APs 106. In some embodiments, those connections are facilitated and authorized by the access controller 200. The specific terms and conditions 136 can also control established connections.

In some embodiments, the APs 106 or the wireless service providers 210 can also have an accounting engine 130 that can store usage records 132. The accounting engine 130 can be implemented as one or more processors at the AP 106. The accounting engine 130 in FIG. 2 is located at the AP 106 and described in connection with the AP 106 for convenience, however the functions of the accounting engine 130 can also be performed by the ISP 206. In some embodiments, the accounting engine 130 can be present in an access control gateway server or the network. The accounting engine 130 can be controlled by the connectivity provider or wireless service provider 210 (e.g., the cellular provider 108 or the sponsor 112) that controls and manages the various APs 106. In some embodiments, the accounting engine 130 can be embedded in the functionality of the AP 106 or a cloud-based implementation to track the capacity that provided to the device 102.

In some embodiments, the device 102 may report usage records 126 to the access controller 200 during or following use of specific services provided by one of the APs 106. The usage records 126 can be used to determine the fees due from the user of the device 102. The AP 106 can also report the usage records 132 to the access controller 200. Alternatively, the AP 106 can use the usage records 132 for auditing purposes. The access controller 200 may also store usage records (e.g., usage records 204) for reporting, billing, and/or issuing payments for the connectivity services on record.

In some embodiments, when the device 102 receives connection information directly from the proposal engine 134, the terms and conditions 136 in force at the time of the usage may also be recorded by the accounting engine 130.

In other embodiments, usage information may also be available from gateway servers in the network of the APs 106. Such servers may be operated, for example, by the ISP 206, the wireless service providers 210, or operators of other enterprise networks. The usage information for each subscriber (e.g., the device 102) and for each AP 106 is then compiled in different ways and used as the basis for settling the compensation for using the bandwidth with all the parties involved.

### Proposal Engine

The APs 106 can have a proposal engine 134. The proposal engine 134 can be specific to each individual AP 106 and provide information regarding available connections via the AP 106 to the selection engine 120 of the device 102. Only one AP 106 and one proposal engine 134 are shown in FIG. 2 for convenience of description; however each AP 106 (e.g., the APs 106 of FIG. 1) can implement the proposal engine 134 for each available service. The proposal engine 134 can provide real time connectivity information regarding the services provided by the APs 106, the “cloud,” or other location accessible by the device 102 (and the selection engine 120). In some embodiments, a given AP 106 may not use its own proposal engine 134. Instead, that AP 106 can, for example, provide a reference to a proposal engine 134 for a different AP 106 that acts as a proxy proposal engine 134.

The proposal engine 134 can be used by the access point 106 to “announce” or broadcast the availability of services available from the service providers 210 to the mobile device 102. In some embodiments, the “broadcast” can be a portion of a Wi-Fi beacon or other periodic transmissions that alerts wireless users (e.g., the device 102) of its presence in the area and the availability of wireless services.

The proposal engine 134 can provide, for example, access or a reference to the terms and conditions 136 for using a particular wireless connection or connections. The mobile device 102 can reference the terms and conditions 136 to determine whether to use services provided by the AP 106. The terms and conditions 136 from multiple APs 106 can be received at the device 102. The device 102 can then, via the selection engine 120, decide which of the available services best suit the needs or requirements of the device 102. The various factors listed above (e.g., RSSI, SNR, etc.) can be considered in such a selection of services.

In some embodiments, when an AP 106 is added to the system 100, its SSID and other identifying information such as a MAC address can be registered with the access controller 200, for use with, for example, the BX Market. In some embodiments, the AP 106 may have two or more SSIDs and may establish priorities for traffic in each SSID identity. This can allow, for example, a user of the device 102 to set preferences giving priority to personal or user-related data and traffic to the device 102. This can then designate that only excess capacity in active connections is made available for micro-commerce through the system 100. In some other embodiments, users can establish separate connections to the system 100 via a designated port, such as an Ethernet port of a home gateway. The user can then specifically register such ports for use with the system 100.

In still other embodiments, service providers 210 can set terms and conditions 136 that allocate different priorities for traffic with different devices 102. In these cases the owners of the APs 106 can manually select high priority for certain devices 102. Alternatively, the APs 106 can be provisioned to automatically provide higher priority to devices 102 with high signal strengths (e.g., RSSI) and frequent long term connections. In some examples, this can be a device 102 belonging to the owner(s) of the AP 106.

The AP 106 or gateway can also have the ability to transmit its terms and conditions 136 directly to connected devices 102. This can be, for example, the transmission of price and other proposal information via the 802.11u protocol. Such a direct form of transmission may be the preferred mechanism of automatically negotiating connectivity commerce. Alternatively, the service provider 210 can store terms and conditions 136 at the access controller 200 as terms and conditions 202. In some embodiments, the terms and conditions 202 can be linked to specific SSIDs (or other identifying information) for the APs 106. For example, the MAC address can be used for this purpose. In such an embodiment, the selection engine 120 can receive the terms and conditions 202 from the access controller 200. The access controller 200 can automatically downlink or transmit the SSID's, authentication information, and the terms and conditions 136 for all APs 106 registered and/or authorized for use with the access controller 200.

In some embodiments, the mobile device 102 can use connectivity services for a new communication or an existing communication (e.g., changing and/or adding connectivity services). For example, when the device 102 needs to initiate a new communication, the device 102 can receive information regarding available APs 106 and select one, two, or more APs 106 for connection. In some embodiments, the connections can be simultaneous. The device 102 can change or add connectivity services providers for an existing communication. For example, when the device 102 has changed location or the characteristics of the existing communication (e.g., performance) have changed, the device 102 can request information about available APs 106 and select one or more access points to use for the existing communication based on the terms and conditions 136.

The terms and conditions 136 can include detailed information about the characteristics of a given connection with the AP 106. The terms and conditions 136 can include pricing information, location restrictions, or certain device 102 requirements for the use of the wireless services provided by the AP 106. For example, pricing can be per byte of data, for specific data rates, and/or per unit of time (e.g. minutes, hours). In some embodiments, pricing can also be service-specific. For example, the device 102 may have to accept the presentation of certain advertisements or other marketing material in exchange for wireless service from the AP 106. In some embodiments, certain time limits may be imposed on the connection between the device 102 and the AP 106, after which a connection can be ended. In some embodiments, service may be restricted to certain geographic locations or may be only provided to certain types of devices 102 or devices 102 running specific programs or applications. For example, the type of device can relate to the service provider 210 or a manufacturer of the device 102. Implementations of the proposal engine 134 can vary depending on the sophistication and capabilities of the AP 106 and the associated operating or controlling entity. Other variables can include technical and business arrangements that provide the internet connectivity for the AP 106.

In some embodiments, the some or all of the functions of the proposal engine 134 at the device 102 can be associated with or incorporated into the access controller 200 as described below.

### Access Controller

In some embodiments, the access controller 200 can receive information from each of the wireless service providers 210 (e.g., the cellular provider 108, the hotspot 110, etc.) information regarding their individual terms and condition 136. The access controller 200 can then store the terms and conditions (e.g., the terms and conditions 136) in one or more memories as terms and conditions 202.

The access controller 200 can also receive and store the usage records 126 from the device 102 and the usage records 132 from the AP 106. The access controller 200 can also receive and store similar usage records from the ISP 206 or the service provider 210. The device 102 can report the usage records 126 periodically as required by the terms and conditions 136 of a given service. The access controller 200 can maintain a central repository for such records saved as usage records 204. Accordingly, the access controller 200 can determine billing amounts or fees due from the user of the device 102 for services consumed by the device 102. The access controller 200 can then also determine how such fees are distributed amongst or credited to the individual service providers 210.

In some embodiments, the access controller 200 can also have a proposal engine 230. The proposal engine 230 can consolidate some or all of the functions of the proposal engines 130 of any of the associated APs 106.

In at least one embodiment, less sophisticated APs 106 may only broadcast their service set identifier (SSID) and media access control (MAC) address, as opposed to additional information indicating available services or terms and conditions 136. In such an embodiment, the functions of the proposal engine 134 can be implemented within the access controller 200, at the proposal engine 230. The device 102 can receive the beacons of the specific AP 106 and transmit a request to the access controller 200 for the terms and conditions 136. The device 102 can transmit the request using the information identifying the AP 106, for example SSID, location, and/or MAC address. In some embodiments, such a request can be included in registration or login credentials (e.g., username and password) used by the device 102. In some other embodiments, the access controller 200 can periodically provide such information about the APs 106 to the device 102, for example, in a periodic message.

In an embodiment, this process can also be facilitated by including an indication or information about its association with the access controller 200 within the SSID of the AP 106. For example, the SSID of the AP 106 may include an identifier or code indicating such association. Accordingly, the selection engine 220 would then be able to check for the terms and conditions 202 at the access controller 200 using a specific identifier of the AP 106. This can alleviate a need to poll every MAC address of every AP 106, for example, participating in the BX Market.

In another embodiment, the access controller 200 can provide real time downloads of MAC addresses and associated terms and conditions 202 of participating APs 106 located in the vicinity of the device 102. The access controller 200 can use the geographic location of the device 102 in order to generate a list, (e.g., a “white list”) of approved APs 106 in the vicinity. Location information regarding the device 102 can be obtained from a global positioning system (GPS) onboard the device 102. Location information for the APs 106 can be determined via GPS, or alternatively by receiving information from the APs 106 regarding SSID's or MAC addresses of other APs 106 within range. This can expedite access to the relevant terms and conditions 202 and provide relevant information to the device 102 even when the device 102 does not have an open data connection to the internet or the access controller 200. For rapidly changing locations such as for example when the device 102 in a moving vehicle, the access controller 200 can extend the range of APs 106 in the list to include in the direction of the movement.

In some embodiments, the terms and conditions 136 at the APs 106 can be associated with a specific or predetermined time or lifespan. That is, the terms and conditions 136 can have short or limited periods of validity set by the service providers 210. In such an embodiment, connections between the device 102 and the AP 106 may require re-negotiation at specific intervals. In some embodiments, this can be a result of needs of the device 102 or varying capacity of the AP 106. In some embodiments, the proposal engine 230 can periodically transmit the relevant validity periods to the device 102. This can be completed in addition to the terms and conditions 202.

In some embodiments, the terms and conditions 202 can account for numerous factors or aspects of the associated wireless service. The factors can be set in the AP 106 locally within their own terms and conditions 134. Alternatively, the access controller 200 can also set terms and conditions 202 that can be instituted globally; that is, across some or all of the links managed by the access controller 200.

In an embodiment, a factor may be a price of using the connection with the AP 106. Such fees may vary according to time of day or the day of the month or year. Fees can also depend on other variables such as current demand from multiple devices 102.

In an embodiment, the level of security available to the connection with the AP 106 may be a factor. Some APs 106 may require that the connecting device 102 have a certain level of security. In another embodiment, it may require an absence of security.

In an embodiment, a factor may include historical data regarding available bandwidth available to the connection, packet loss, link stability, jitter, and other connection-oriented parameters. The selection engine 220 can use this data but may also require that the device 102 conduct local tests of connection characteristics.

In an embodiment, the terms and conditions 202 can also be determined based on information about special promotions or sponsorship for the connection. For example connection with the AP 106c can be associated with the sponsor 112. The sponsor 112 may require that connection with the AP 106c feature certain advertisements. In some embodiments, the nature of the products advertised and the frequency and obtrusiveness of the advertisements can be communicated to the selection engine 220. This is additional information that can be implemented for good decision-making regarding commercially beneficial or desirable connections. For example, some end users may be interested in advertisements of topics of interest, may not want to receive advertisements of other topics.

In some embodiments, special instructions from the service providers 210 or other information pertaining to the terms and conditions of using the AP 106 may also be relevant. For example, some APs 106 may belong to a network of hotspots controlled by a wireless operator (wireless service provider 210) or ISP 206 that offers fixed-fee or other special pricing to subscribers of their services. In the event the device 102 is a subscriber to such a network, the terms and conditions 136 can be stored in the selection engine 120 and the hotspot access point 106b can provide information identifying that it belongs to the group. In some examples, such information can be indicated within the SSID of the hotspot AP 106b. Alternatively, information about the AP 106 belonging to a specific group of wireless ISP hotspots and its impact to the cost of using it can be communicated through the proposal engine 230.

In some embodiments, the service providers 210 can transmit special information to the device 102. In some embodiments this can be a direct transmission via the respective AP 106. In some other embodiments, the information can be delivered via the access controller 200. For example, a given cellular provider 108 may have certain terms and conditions 136 that indicate that it is desirable to transfer the connection to an available Wi-Fi AP 106 (e.g., the hot spot AP 106b or free public Wi-Fi 116) depending on the load on the tower (e.g., cellular provider 108) to which the device 102 is connected. In some embodiments, if the load on the cellular provider 108 is high, the proposal engine 134 of the AP 106a (operated by the cellular provider 108) may cause the device 102 to connect with a lower price alternative even when a connection to the AP 106a would be available. This can aid the service providers 210 to manage the connections in an optimal way.

The level of sophistication of the proposal engine 134 and the selection engines 120 may determine whether all of these factors are included in the decision-making about the connection to select. For example, it is possible that the selection engine 120 is only capable of selecting based on signal strength and price. However, more sophisticated decisions are possible by providing more information and alternatives in the terms and conditions 136 by the proposal engine 134 and increasing the capabilities in the selection engine 120.

The access controller can also have a market server 250. The marker server can be associated with or be implemented as a part of the selection engine 220. The market server 250 can have one or more processors and one or more databases or memories storing information about all of the APs 106 associated with the access controller 200. In some embodiments, the market server 250 can make commercial decisions regarding pricing and whether a particular connection with a given AP 106 is desirable for the device 102.

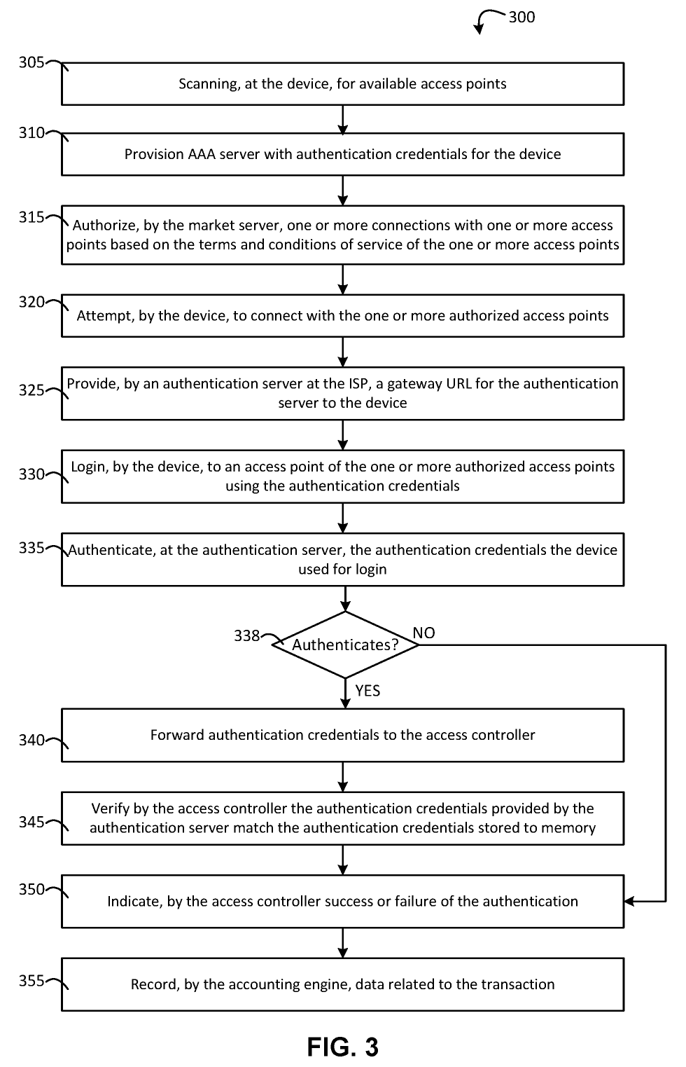

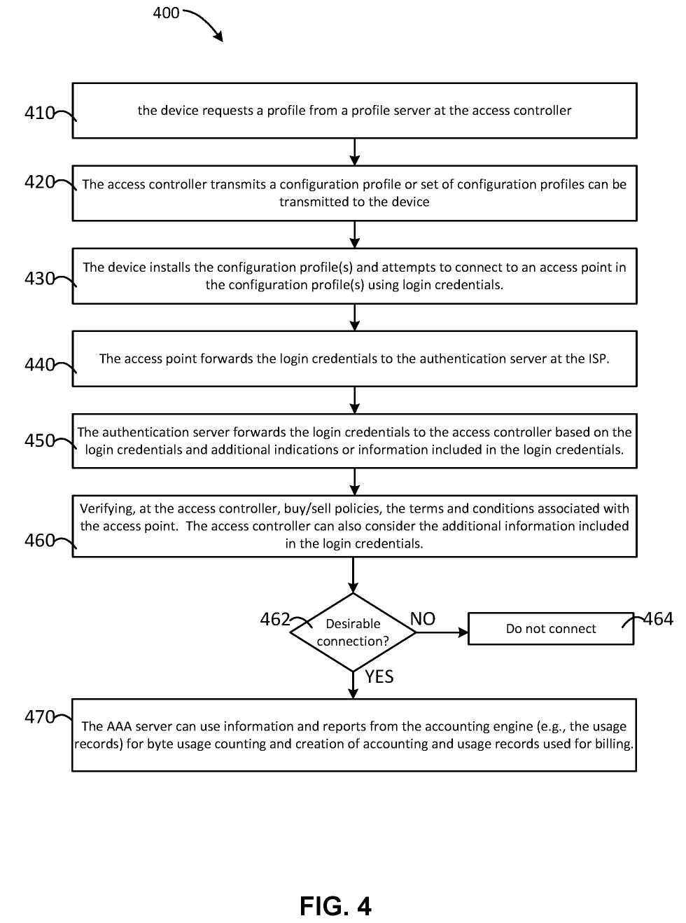

In some embodiments, the “selection” of services used by the device 102 can be conducted at a location external to the device 102. In such an embodiment, the access controller 200 can have a selection engine 220. The selection engine 220 can function in a similar manner to the selection engine 120 resident in the device 102. The selection engine 220 can perform some or all of the function of the selection engine 120 within the device 102. The selection engine 220 can further consider each of the factors indicated above when selecting a service for the device 102. Accordingly, the selection process can be conducted at the access controller 200 on behalf of the device 102. In some embodiments, the access controller 200 can implement centralized access control method for various services. These methods are described below in connection with FIG. 3 and FIG. 4.

In order to utilize an off-board selection engine 220, the device 102 can implement a “passpoint” mechanism, such as Hotspot 2.0. The device 102 can also make use of 802.11x protocols or the Wireless Internet Service Provider roaming (WISPr) mechanism for authentication and authorization to establish a connection. WISPr can allow users (e.g., the device 102) to roam between wireless internet service providers, in a fashion similar to that used to allow cellphone users to roam between carriers. A Remote Authentication Dial-In User Service (RADIUS) server is used to authenticate the subscriber's credentials. The RADIUS server can provide centralized Authentication, Authorization, and Accounting (AAA or Triple A) management for users who connect and use a network service.

In such an embodiment, the access controller 200 can have an AAA server 240. The AAA server 240 handles user requests (e.g., from the device 102) for access to computer resources. The AAA server 240 can also provide authentication, authorization, and accounting services. In some examples, the AP 106 may require credentials (e.g., a user name and password) in order to acquire access to the services offered (e.g., the Internet). These credentials can then be passed from the device 102 via the AP 106 to the AAA server 240. In some embodiments, the ISP 206 can also have an authentication server 260. The authentication server 260 can communicate with the device 102 via the AP 106 during certain authentication processes or methods. In some other embodiments, the AAA server 240 can also communicate with the authentication server 260 to complete certain authentication processes or methods according to, for example, WISPr, Hotspot 2.0, or Passpoint.

The selection engine can also have a profile server 235. The profile server 235 can be implemented in addition to or as a part of the selection engine 220. In some embodiments, the profile server 235 can be implemented as one or more processors and one or more memories. The profile server 235 can store information related to the APs 106 that are associated with the access controller 200. The APs 106 can have desirable services, characteristics, and terms and conditions 136 or that are commercially beneficial to the device 102. Such information can be periodically updated to account for time-dependent variations. For example, certain wireless connections may be more desirable during a certain time of day or during a certain time of year. In other embodiments, location can determine commercial desirability. The profile server 235 can generate, update, and/or maintain configuration profiles (also referred to as “profiles” herein) that can be provided to the device 102 periodically or on demand. The configuration profiles can include information relating to connections with the APs 106 that have been authorized by the access controller 200, or more specifically, the market server 250.

FIG. 3 is a flowchart illustrating a method for access control within the system of FIG. 2. A method 300 depicts a process for using the selection engine 220 at the access controller 200. The method 300 is an exemplary implementation of an access control mechanism used in authenticating access to alternative network access points (e.g., the APs 106). In some embodiments, the method 300 can incorporate the WISPr mechanism. While WISPr is described in relation to the method 300, this disclosure is not so limited. Other authentication systems can be implemented without departing from the scope and spirit of the disclosure.

In some embodiments, the method 300 can incorporate the XML coding language to pass credentials between the device 102 and the access control server, or access controller 200. The access controller 200 can provide “just in time,” or on demand, credentials on the AAA server 240 specifically for one connection at a time. The access controller 200 can also remove the credentials from the device 102 so that it cannot re-connect without receiving a new authorization.

In an embodiment, the method 300 begins at block 305, when the device 102 scans for available APs 106. In some embodiments the scanning capability and the specific interface can be provided through the use of a specific application or app. For example, the app may be one specifically suited for use with the access controller 200. The device 102 can scan for available APs 106, for example, by receiving various beacons or signals from the APs 106. The device 102 can then forward a list of available the APs 106 (e.g., those within wireless range) to the access controller 200. The device 102 can also forward or transmit a list of preferred APs 106 based on, for example, their terms and conditions 136. The access controller 200 can reply to the device 102 with an ordered, or prioritized, list of the APs 106 to which the device 102 is authorized to connect.

At block 310, the access controller can provision the AAA server 240 with (or store to a memory) authentication credentials for the device 102. In some embodiments, the authentication credentials can be WISPr credentials. In such an embodiment, the access controller 200 can provision authentication credentials to the AAA server 240 for one AP 106 or several at a time.

At block 315, the market server 250 can render a business judgment based on pricing and/or the terms and conditions 202 and authorize the device 102 to connect with the AP 106. The access controller 200 can then forward WISPr credentials to the device 102 for use in associating with the AP 106.

At block 320, the device 102 can initiate or attempt a connection with the AP 106 using the authentication credentials provided by the access controller in block 315.

At block 325, the authentication server 260 at the ISP 206 can then provide the device 102 a gateway URL for the authentication server 260 via the AP 106. In some embodiments, the authentication server can be a Captive Portal/WISPr Server 334.

At block 330, the device 102 logs into the AP 106 using the authentication credentials (e.g., the WISPr credentials) provided in block 325, which are passed to the authentication server 260 via the AP 106.

At block 335 the authentication server 260 (e.g., the Captive Portal/WISPr Server 334) authenticates the authentication credentials the device 102 used for login. If the credentials are correct, at decision block 338, at block 340, the authentication server 260 forwards authentication credentials to the access controller AAA server 240. At block 345 the AAA server 240 can then verify the credentials using the authentication credentials stored to memory at block 310. Thus, blocks 340 and 345 “close the loop” and prevent unauthorized authentication attempts by the device 102.

At decision block 338, if the authentication credentials are not correct or are not authenticated, the method 300 moves to block 350.

At block 350, the AAA server 240 returns an indication of success or failure of the verification of block 340 to the authentication server 260. The indication of success or failure is routed through the access controller AAA server 240 to the authentication server 260 and to the AP 106, ultimately to the device 102. If a success, the device 102 can then access the Internet with an authenticated and authorized connection via the AP 106. In some embodiments, the authentication credentials (e.g., the WISPr credentials) can then be deleted from the device 102. This prevents future unauthorized access via the AP 106.

At block 355, the device 102, and more particularly the accounting engine 124, can record transaction data and any required reports to the usage records 126. In some embodiments, the usage records 126 can then be reported to the market server 250. In some embodiments, the AP 106 (e.g., the accounting engine 130) can generate the usage records 132 and report them to the access controller 200 that then saves the reports to the usage records 204.

According to the method 300, provisioning the necessary authentication credentials to the AAA server 240 on demand, or “just in time,” allows the functions of the selection engine 120 to be moved out of the device 102 into the selection engine 220. Authorization can then be granted by the access controller 200 based on a determination as to whether connection to a given AP 106 is desirable. In this way, if the connection is desirable, the access controller can authorize the connection. If the connection is not desirable, authorization can be withheld.

FIG. 4 is a flowchart depicting a method for authorization and authentication of a connection in wireless communication. In some embodiments, the device 102 can have specific profiles for use with authorization and authentication of wireless connections between the device 102 and the APs 106. In some embodiments, the system 100 can implement a Passpoint Wi-Fi automation mechanism. In some embodiments, certain devices 102 running on an Apple iOS operating system can implement those portions of the method performed by devices 102.

A method 400 can begin at block 410 when the device 102 requests a profile from the profile server 235 at the access controller 200. The profile server 235 can be a portion of the selection engine 220 as described above. In some embodiments, the profile request can be sent automatically from the device 102 absent user input. In some other embodiments, the profile request can be sent upon activation of a function or app requiring access to the Internet, for example. This can be web browser app on the device 102. For example, the browser can be a Safari web app on an Apple iOS device. Alternatively, the access controller can send a profile or updates to a profile to the device 102 without a request, for example, periodically.

The profile request can be sent with a device certificate. The device certificate can be information that identifies the request as one coming from a particular device 102. In some embodiments the certificate can include sim card information or an International Mobile Equipment Identity (IMEI) number or other information identifying the device 102 as being associated with a particular wireless carrier, (e.g., the wireless service provider 210) or ISP 206. The profile server 235 (or selection engine 220) can also validate the device 102 with the carrier. This can be accomplished by communication between the profile server 235 and the ISP 206. This validation confirms that the device is “in good standing” with its respective service 210 provider and the service provider 210 is willing to buy network access services for the device in accordance with the policies provided to the access controller 200. This validation may have a “time to live” TTL which indicated hen a re-validation will be required.

At block 420, the access controller 200 can transmit a configuration profile or set of configuration profiles to the device 102. The configuration profile can define the types of APs 106 and/or to which specific APs 106 that the device 102 is authorized to automatically attempt association. In some embodiments, this authorization can come from the market server 250 (e.g., the access controller 200). The configuration profile can include a list of SSIDs to which the device 102 is authorized to automatically attempt association. In some embodiments the contents of the profiles can vary, for example, from location to location, or country to country. The configuration profile can also contain encoded identifiers for specific APs 106. The encoded device identifiers can be used by the selection engine 220 and for authentication of the device 102.

At block 430, the device 102 installs the configuration profile and can initiate a connection with the APs 106 described in the configuration profile and identified, for example, by scanning as was described in connection with step 305 in FIG. 3. In some embodiments, the process of block 430 may only occur periodically as the profiles may not change significantly over time.

Whether the connections are attempted or initiated may further be dependent on signal strength (e.g., RSSI) and other parameters known to the device 102 at the time of the connection attempt. In this embodiment, the connection process can include providing login credentials (e.g., the username and password) to the AP 106. The login credentials can include a username and password, in addition to other information usable by the access controller 200 (e.g., the market server 250) to determine if the requested connection is desirable or authorized. In some embodiments, this additional information can be added or appended to the credentials by the device 102 when the connection with the AP 106 is initiated. For example, the login credentials can then have or contain specific codes, terms, or special character embedded that provide indications of connection desirability. For example, the additional information can be certain time varying information such as signal strength or type of service. The additional information may also contain other situation-specific information such as detailed identification of the AP 106 with which connection is initiated or attempted. The identifiers can be a basic service set identifier (BSSID), MAC address, or some other network or other identifier observable to the device 102.

At block 440, the AP 106 can then forward the login credentials to the authentication server 260 at the ISP 206. In some embodiments, the authentication server 260 can be a server implementing Passpoint (a “Passpoint server”).

At block 450, the authentication server can forward the login credentials to the AAA server 240 (at the access controller 200) based on the login credentials and any additional included indications or information.

At block 460, the selection engine 220 at the access controller 200 can verify buy/sell policies and the terms and conditions 202 to verify that connecting with the AP 106 is desirable. The access controller 200 can also consider the additional information included or added by the device 102 in the login credentials during the association or connection attempt with the AP 106. The market server 250 can then check or verify market policies, combine information from the login credentials with the information already stored at the market server 250. The market server 250 can then make the commercial decision as to whether the connection is desirable. If the connection is desirable, the access controller 200 can return an authorization for the connection (via a RADIUS server, or the AAA server 230) to the authentication server 260 of the ISP 206 controlling access to the Internet. The access controller 200 can also validate the device 102 with carrier (e.g., the wireless service provider 210) again or may rely on previous validation and authorization records (e.g., at block 410). In some embodiments, the authorization records can have a “time to live” rendering the records useless or invalid after a specified period of time.

If the connection is desirable at decision block 462, the access controller 200 can grant access to the device 102. If the connection is not desirable, the access controller 200 can deny access at block 464.

At block 470, the AAA server 240 (e.g., a RADIUS server) can use information and reports from the accounting engine 130 (e.g., the usage records 132) for byte usage counting and creation of accounting and usage records 204.

The method 400 can provide a number of benefits. In some embodiments, if a connection is not authenticated by the access controller 200, the device 102 can automatically disassociate from the AP 106. The automatic dissociation occurs because authentication is part of the association process of many wireless standards, for example, the IEEE 802.11x standard or Passpoint. If the authentication fails, so does the connection to the AP 106.

In some embodiments when there is no authentication as a part of the associated process the device 102 can remain associated on the AP 106 even in the event that the authentication fails. In this case, there are two alternative mechanisms to assure that data connectivity remains functional.

First, a separate process is implemented at the device 102 to disassociate from the AP 106 in event the connection is not authorized. In this case the data connection can automatically be transferred to another available network access alternative authorized by the access controller 200.

Second, the initial data connection between the device 102 and the AP 106 can remain active in parallel with associating and authenticating the connection to another AP 106. In some embodiments, these can be referred to as Multi-path IP connections.

In some embodiments, when continued data connectivity is available through another data access network, for example the LTE network connection, the fact that the device 102 may remain associated to the AP 106 without an internet connection does not cause a disruption in data flow or in the user experience. Eventually when the device 102 moves out of range the device 102 will automatically disassociate from the AP 106.

In order to support the decision making about which wireless, (e.g., cellular, Wi-Fi, Bluetooth) connections to use, the device 106 can independently provide information to the selection engine 220 about the location of the device 102, quality of the connection the given AP 106, including Wi-Fi connections and other connections and information about the cellular sector radio identifiers. The device 102 can further transmit operation, location, and environmental information to the selection engine 220. For example, the device 102 can relay information relating to observations regarding the available APs 106 the device 102 observes during Wi-Fi scans.

In some embodiments, certain purchase and sales agreements may govern transactions between the device 102, the access controller 200, the wireless service providers 210 (who control or operate the APs 106), and the ISP 206. Depending on the terms and conditions 136 and the agreements in place, bandwidth and access to the internet via the APs 106 can be offered for sale via the access controller 200 and for example, the BX Market. In return, the wireless service providers 210 can bill their customers (e.g., the users of the device 102) use of the wireless service in accordance with subscription agreements.

In some embodiments, the access controller 200 can establish direct relationships with the end-users of the device 102. In such an embodiment, the access controller 200 can provide capacity directly to the device 102. Such an arrangement can be facilitated through fixed-price or per use, price per byte or data rate, or other commercial arrangements using prepaid or postpaid agreements. In some embodiments, a barter arrangement can be established whereby, for example, an owner of the AP 106d (e.g., the home Wi-Fi connection) is also the owner of the device 102. In such an embodiment, wireless service via the access controller 200 can be exchanged for providing access to the AP 106d for other devices 102 registered with the access controller 200.

In some embodiments, third-party aggregators can create agreements with the users of the device 102 or with the owners of the APs 106. Such aggregators can negotiate “wholesale” terms of for access to wireless services via the access controller 200. The access controller 200 can then use the usage records 204 (and the usage records 132) provided by the accounting engine(s) 130 for determining payment to the bandwidth the wireless service providers 210.

In some embodiments, the home network 114, for example, and the associated AP 106d can register with the access controller 200 within the BX Market. Access to the wireless service (by the device 102) provided by the AP 106d then is controlled at the access controller 200. The user of the device 102 can then pay a subscription for service. In some embodiments, payment to the wireless service providers 210 for such service may be paid through their particular ISP 206. In such an embodiment, compensation paid via the BX Market can offset any fees due to the ISP 206 for access to the Internet. The ISP 206 may provide bundled services including telephony, Internet, and television services. Thus the total bill may be large enough so that this compensation mechanism can be used even for owners of the APs 106 owners that have great deal of BX Market traffic flowing through their connection.

In certain embodiments, participants (e.g., the owners of the devices 102) can be considered sponsors of the wireless connectivity. Through agreements with hotspot owner organizations, or individual owners of the APs 106 (e.g., the wireless service providers 210), various companies can offer to pay for bandwidth in return advertisement space or commercial messages to the end-users at the device 102. In some embodiments, the terms and conditions 136 can contain a requirement that the device 102 display such ads or messages in return for wireless access. In some embodiments, the use of bandwidth can be sponsored only for accessing specific websites or other services. For example, access to sites that offer specific products for sale may be sponsored by the owners of the sites. In these cases the BX Market can provide, via the access controller 200, billing to, and collect payments from the sponsors for the usage (based on the usage records 132, 204) of the sponsored bandwidth.

Through the access controller 200, the BX Market can enable local micro-commerce for wireless connectivity and data transfer capacity. This is possible by making information such as the terms and conditions 136 available to potential buyers (users of the devices 102) from potential sellers, or the wireless service providers 210 as owners of the APs 106. The micro-commerce transactions can then be made on a per unit basis between the providers 210 and the device 102. Through transactions and collection of the usage records 132, 204, the access controller 200 (and the BX Market) can accrue detailed information about the need, acceptable pricing, and availability of wireless connectivity and data transfer capacity in different locations at different times.

Compensation for access to the APs 106 facilitated by the access controller 200 can be implemented in a number of ways. In some embodiments, a brokerage fee arrangement can be implemented. A broker can charge a percentage of the value of each transaction mediated through the access controller 200 (and the BX Market). In such an embodiment, the proposal engine 134 can include, within the terms and conditions 136, an indication of a brokerage fee associated with a given transaction.

In some embodiments, an intermediary business can be based on the use of the access controller 200 within the BX Market. The intermediary can negotiate terms and conditions (e.g., the terms and conditions 136) with the wireless service providers 210. Bandwidth and access can then be provided to the device 102 at the negotiated rates.

In some embodiments, a subscription or membership fee may be charged to allow the device 102 to use the services provided by the APs 106 via the access controller 200.

In some embodiments, information about the access controller 200 and the BX Market marketplace needs and activities in different localities may be sold to market participants and infrastructure or service providers

The access controller 200 can facilitate participation of new sellers and buyers in the BX market by establishing and communicating local price levels.

The access controller 200 and the BX Market can enable trade in or enable other market participants to create, buy, or sell sophisticated contracts including guaranteed minimum bandwidth, duration of the arrangement, characteristics of the bandwidth, for example reliability, jitter and packet loss.

The access controller 200 and the BX Market can create or trade in or enable other market participants to create, buy, or sell futures contracts on bandwidth in specific locations. For example providing bandwidth during meetings or conventions in specific locations may offer an opportunity to sell it at higher prices.

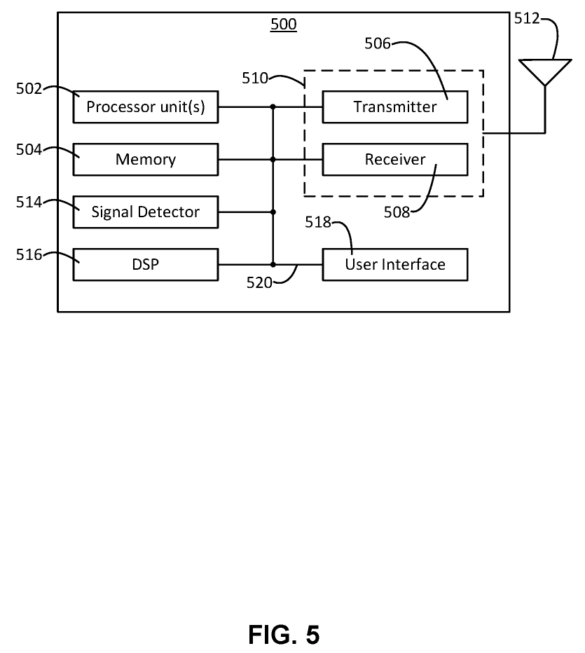

FIG. 5 is a functional block diagram of a wireless communication device that can be employed within the wireless communication system of FIG. 1. A wireless device 500 is an embodiment of a device that can be configured to implement the various methods described herein. For example, the wireless device 500 can include the one or more of the APs 106 or the device 102. In some other embodiments, at least a portion of the wireless device 500 can also be implemented as the access controller 200.

The wireless device 500 can include one or more processors or processor units 502. The processor 502 can controls operation of the wireless device 500. The processor 502 can also be referred to as a central processing unit (CPU). The wireless device 500 can also have a memory 504 coupled to the processor 502. The memory 504 can include both read-only memory (ROM) and random access memory (RAM). The memory 504 can provide instructions and data to the processor 502. At least a portion of the memory 504 can also include non-volatile random access memory (NVRAM). The processor 502 can performs logical and arithmetic operations based on program instructions stored within the memory 206. The instructions in the memory 504 can be executable to implement the methods described herein. In some embodiments, the memory 504 can be implemented to store, for example, the rules and policies 122 and the usage records 126 at the device 102. In some other embodiments, the memory 504 can also be implemented to store, for example, the terms and conditions 136 and the usage records 132 at the AP 106. In some other embodiments, the memory 504 can also be implemented to store, for example, the terms and conditions 202 and the usage records 204 at the access controller 200.

The processor 502 can include or be a component of a processing system implemented with one or more processors 502. The one or more processors can be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system and the memory 504 can also include machine-readable media for storing software. Software shall be construed broadly to mean any type of instructions, whether referred to as software, firmware, middleware, microcode, hardware description language, or otherwise. Instructions can include code (e.g., in source code format, binary code format, executable code format, or any other suitable format of code). The instructions, when executed by the one or more processors, cause the processing system to perform the various functions described herein.

The wireless device 500 can also include a transmitter 506 and/or a receiver 508 to allow transmission and reception of data between the wireless device 500 and a remote location. The transmitter 506 and the receiver 508 can be combined into a transceiver 510. The wireless device 500 can also have one or more antennas 512 electrically coupled to the transceiver 510. The wireless device 500 can also include (not shown) multiple transmitters, multiple receivers, multiple transceivers, and/or multiple antennas as needed for various communication standards.

The transmitter 506 can be configured to wirelessly transmit packets having different packet types or functions. For example, the transmitter 506 can be configured to transmit packets of different types generated by the processor 502. When the wireless device 500 is implemented or used as one or the APs 106 or the device 102, the processor 502 can be configured to process packets of a plurality of different packet types. For example, the processor 502 can be configured to determine the type of packet and to process the packet and/or fields of the packet accordingly. When the wireless device 500 is implemented or used as one of the APs 106, the processor 502 can also be configured to select and generate one of a plurality of packet types. For example, the processor 502 can be configured to generate a discovery packet including a discovery message, beacon, or other information, and to determine what type of packet information to use in a particular instance. Such information can include the terms and conditions 136 or other information necessary for the proposal engine 134 or the proposal engine 230.

The receiver 508 can be configured to wirelessly receive packets having different packet types. In some examples, the receiver 508 can be configured to detect a type of a packet used and to process the packet accordingly.

In some embodiments, the transmitter 506 and the receiver 508 can be configured to transmit and receive information via other wired or wireline systems or means.

The wireless device 500 can also include a signal detector 514 that can be used in an effort to detect and quantify the level of signals received by the transceiver 214. The signal detector 514 can detect such signals as total energy, energy per subcarrier per symbol, RSSI, SNR, power spectral density, and other signals pertaining to the factors described above. The signal detector 514 can provide information to the access controller 200 to aid in the determination as to whether a given connection to one of the APs 106 is desirable or not. The wireless device 500 can also include a digital signal processor (DSP) 516 for use in processing signals. The DSP 516 can be configured to generate a packet for transmission.

The wireless device 500 can further include a user interface 518. The user interface 518 can include a keypad, a microphone, a speaker, and/or a display. The user interface 518 can include any element or component that conveys information to a user of the wireless device 500 and/or receives input from the user.

The various components of the wireless device 500 can be coupled together by a bus system 520. The bus system 520 can include a data bus, for example, as well as a power bus, a control signal bus, and a status signal bus in addition to the data bus. The components of the wireless device 500 can be coupled together or accept or provide inputs to each other using some other mechanism.

Although a number of separate components are illustrated in FIG. 5, one or more of the components can be combined or commonly implemented. For example, the processor 502 can be used to implement not only the functionality described above with respect to the processor 502, but also to implement the functionality described above with respect to the signal detector 514 and/or the DSP 516. In some embodiments, each of the components illustrated in FIG. 5 can be implemented using a plurality of separate elements.

Those of skill will appreciate that the various illustrative logical blocks (e.g., the various servers described herein), modules, and algorithm steps described in connection with the embodiments disclosed herein can often be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the design constraints imposed on the overall system. Skilled persons can implement the described functionality in varying ways for each particular application, but such implementation decisions should not be interpreted as causing a departure from the scope of the disclosure. In addition, the grouping of functions within a module, block or step is for ease of description. Specific functions or steps can be moved from one module or block without departing from the disclosure.

The various illustrative logical blocks and modules (e.g., the various servers described herein) described in connection with the embodiments disclosed herein can be implemented or performed with a general purpose processor, a digital signal processor (DSP), application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method blocks or elements identified, but that such blocks or elements do not comprise an exclusive list and a method or apparatus may contain additional blocks or elements.

It will be understood that the above descriptions of various embodiment are given by way of example and not by limitation. Accordingly, various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this disclosure.

The above description of the disclosed embodiments is provided to enable any person skilled in the art to make or use the subject matter disclosed. Various modifications to these embodiments will be readily apparent to those skilled in the art, and the generic principles described herein can be applied to other embodiments without departing from the spirit or scope of the disclosure. Thus, it is to be understood that the description and drawings presented herein represent a presently preferred embodiment of the disclosure and are therefore representative of the subject matter, which is broadly contemplated. It is further understood that the scope of the present disclosure fully encompasses other embodiments that may become obvious to those skilled in the art.

What is claimed is:

1. A method for operating an access controller for wireless communication comprising:
transmitting, at the access controller, a configuration profile to a wireless device, the configuration profile identifying one or more authorized access points;
receiving, from an authentication server, login credentials used by the wireless device to initiate a connection with an access point of the one or more authorized access points, the login credentials including additional information added by the wireless device;
determining, at the access controller, based on information associated with the access point and the additional information, that the connection is desirable; and
allowing the connection between the wireless device and the access point.

2. The method of claim 1 further comprising tracking one or more transactions between the wireless device and the access point; and
storing the tracked one or more transactions as usage records to a database.

3. The method of claim 1 further comprising receiving usage records from the access point, the usage records including information related to or more transactions between the wireless device and the access point.

4. The method of claim 1 further comprising receiving usage records from the wireless device, the usage records including information related to or more transactions between the wireless device and the access point.

5. The method of claim 1 further comprising:
receiving a profile request from a wireless device; and
transmitting the configuration profile based on the profile request.

6. The method of claim 1 wherein the additional information is added to the login credentials when the wireless device initiates the connection with the access point.

7. The method of claim 4 wherein the additional information includes at least one of
a signal strength;
a signal to noise ratio;
a location; and
a type of service.

8. The method of claim 1 further comprising:
receiving terms and conditions regarding a plurality of access points;
comparing the terms and conditions of the one or more access points; and
determining the one or more authorized access points based at least in part on the comparing.

9. An access controller for wireless communication comprising:
at least one memory configured to store one or more configuration profiles, each configuration profile of the one or more configuration profiles identifying one or more authorized access points; and
one or more processors operably coupled to the at least one memory and configured to
communicate a configuration profile of the one or more configuration profiles to a wireless device,
receive, from an authentication server, login credentials used by a wireless device to establish a connection with an access point of the one or more authorized access points in the configuration profile, the login credentials including additional information added by the wireless device,
determine that the connection is desirable based on information associated with the access point and the additional information, and
allow the connection between the wireless device and the access point.

10. The device of claim 9, wherein the one or more processors is further configured to:
track one or more transactions between the wireless device and the access point; and
store the tracked one or more transactions as usage records to the at least one memory.

11. The device of claim 9 wherein the one or more processors is further configured to receive usage records from the access point, the usage records including information related to or more transactions between the wireless device and the access point.

12. The device of claim 9 wherein the one or more processors is further configured to receive usage records from the wireless device, the usage records including information related to or more transactions between the wireless device and the access point.

13. The device of claim 9, wherein the one or more processors is further configured to receive a profile request from a wireless device.

14. The device of claim 9 wherein the additional information is added to the login credentials when the wireless device initiates the connection with the access point.

15. The device of claim 9, wherein the additional information includes at least one of:
signal strength;
a signal to noise ratio;
a location; and
type of service.

16. The device of claim 9, wherein the one or more processors is further configured to communicate the configuration profile to the wireless device based on the profile request.

17. The device of claim 9, wherein the additional information is added to the login credentials when the wireless device initiates the connection with the access point.

18. The device of claim 9, wherein the one or more processors is further configured to receive terms and conditions regarding a plurality of access points.

19. The device of claim 18, wherein the one or more processors is further configured to:
compare the terms and conditions of the one or more access points; and
determine the one or more authorized access points based at least in part on the comparing.

20. An apparatus for wireless communication comprising:
means for transmitting a configuration profile to a wireless device, the configuration profile identifying one or more authorized access points;
means for receiving login credentials used by the wireless device to initiate a connection with an access point of the one or more authorized access points in the configuration profile, the login credentials including additional information added by the wireless device;
means for determining based on information associated with the access point and the additional information, that the connection is desirable; and
means for allowing the connection between the wireless device and the access point.

21. The apparatus of claim 20 further comprising means for tracking one or more transactions between the wireless device and the access point; and
means for storing the tracked one or more transactions as usage records.

22. The apparatus of claim 20 further comprising:
means for receiving a profile request from a wireless device; and
means for transmitting the configuration profile based on the profile request.

23. The apparatus of claim 20 wherein the additional information is added to the login credentials when the wireless device initiates the connection with the access point.

24. The apparatus of claim 20 wherein the additional information includes at least one of
signal strength;
a signal to noise ratio;
a location; and
type of service.

25. The apparatus of claim 20 further comprising:
means for receiving terms and conditions from a plurality of access points;
means for comparing the terms and conditions of the one or more access points; and
means for determining the one or more authorized access points based at least in part on the comparing.

26. A system for wireless communication comprising:
a plurality of access points configured to provide a service;
a wireless device configured to
initiate a connection with an authorized access point of one or more authorized access points of the plurality of access points using login credentials to use the service, and
include, in the login credentials, additional information associated with the authorized access point when initiating the connection; and
an access controller configured to
provide the wireless device with a configuration profile identifying the one or more authorized access points,
receive from an authentication server, the login credentials used by the wireless device to initiate the connection with the authorized access point,
determine, based on information associated with the access point and the additional information, that the connection is desirable; and
allow the connection between the wireless device and the authorized access point.

27. The system of claim 26 wherein the access controller is further configured to track one or more transactions between the wireless device and the authorized access point access point; and
store the tracked one or more transactions as usage records to a database.

28. The system of claim 27 wherein access controller is further configured to receive usage records from the access point, the usage records including information related to or more transactions between the wireless device and the access point.

29. The system of claim 27 wherein access controller is further configured to receive usage records from the wireless device, the usage records including information related to or more transactions between the wireless device and the access point

30. The system of claim 27 wherein the usage records are received from the wireless device.

31. The system of claim 26 wherein the wireless device is further configured to transmit a profile request from a wireless device; and
wherein the access controller is further configured to transmit the configuration profile based on the profile request.

32. The system of claim 26 wherein the additional information is added to the login credentials when the wireless device initiates the connection with the access point.

33. The system of claim 32 wherein the additional information includes at least one of
a signal strength;
a signal to noise ratio;
a location; and
a type of service.

34. The system of claim 26 wherein the access controller is further configured to
receive terms and conditions regarding the plurality of access points;
compare the terms and conditions of the one or more access points; and
determine the one or more authorized access points based at least in part on the comparing.

35. The system of claim 34 wherein the terms and conditions include information related to at least one of
a price per unit of time for wireless services;
a price per service;
a price per data rate of the service;
a restriction on the location of the wireless device when accessing the service;
a requirement that the wireless device accept certain advertising material in return for access to the service;
a requirement that the wireless device have a specific identity;
a restriction on a type of the wireless device; and
a restriction on a type of data accessed by the wireless device.
